(19) United States
(12) Patent Application Publication
(10) Pub. No.: US 2023/0010421 A1
(43) Pub. Date: Jan. 12, 2023

(54) SELF-REPAIRING EXPANDABLE TUBULAR APPARATUS

(71) Applicant: SAUDI ARABIAN OIL COMPANY, Dhahran (SA)

(72) Inventor: Ala-Edeen Herzallah, Dhahran (SA)

(73) Assignee: SAUDI ARABIAN OIL COMPANY, Dhahran (SA)

(21) Appl. No.: 17/371,349

(22) Filed: Jul. 9, 2021

(51) Int. Cl. F16L 15/00

(52) U.S. Cl. CPC F16L 15/003

(57) ABSTRACT

A system includes a box end disposed on a first tubular. The box end includes a first shoulder, a sealing surface, a first distal portion, and first threads disposed between the sealing surface and the first distal portion. The system further includes a pin end on a second tubular. The pin end includes a second shoulder, a second distal portion comprising an extended lip, and second threads disposed between the second shoulder and the extended lip. A first swellable element is disposed around the extended lip and the pin end is inserted into the box end to form the expandable connection. Upon expansion of the expandable connection, the first swellable element seals against the sealing surface. Upon separation of the expandable connection, the extended lip of the pin end acts as a floating seal assembly with the box end acting as a receptacle for the floating seal assembly.

### BACKGROUND

Expandable tubular technologies are generally used for repairing damaged casing, blocking a water leak zone, blocking a lost circulation zone, increasing the inner/outer diameter of casing, saving casing usage in a monobore casing design, and improving sand control efficiency due to the reduced annulus between an expanded screen and the bore hole. When multiple strings of casing or liner are used in a well, each subsequent inner and outer diameter of casing must be reduced to fit the subsequent casing or liner strings through the previous casing or liner strings. To reduce the loss of the inner and outer diameter each time a new casing string or liner is run into a well, expandable tubulars may be run. Expandable tubulars are tubulars, such as casing, liner, or screens, that are able to undergo a cold-working process downhole allowing the tubulars to expand typically up to 20% in diameter after being run into the well.

The cold-working process includes running the tubular into the well and pumping an expansion element, such as an expansion cone, through the inside of the tubular to plastically deform the tubular and increase the inner and outer diameter of the tubular. During the expansion process, and over the life of the well, leaks often occur within the expandable tubular, especially within the expandable connections between two tubulars. It is difficult to repair the leaks within the expandable connections without removing the tubular(s) from the well. Thus, methods and systems that are able to repair any leaks or deformities within expandable tubular's expandable connections, while the tubular is downhole, are beneficial.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure presents, in one or more embodiments, a system and a method for sealing an expandable connection between a first tubular and a second tubular. The system includes a box end disposed at a first end of the first tubular. The box end includes a first shoulder, a sealing surface adjacent to the first shoulder, a first distal portion, and first threads disposed between the sealing surface and the first distal portion. The system further includes a pin end disposed at a second end of the second tubular. The pin end includes a second shoulder, a second distal portion comprising an extended lip, and second threads disposed between the second shoulder and the extended lip. A first swellable element is disposed around an outer circumference of the extended lip and the pin end is inserted into the box end to form the expandable connection. Upon expansion of the expandable connection, the first swellable element seals against the sealing surface. Upon separation of the expandable connection, the extended lip of the pin end acts as a floating seal assembly with the box end acting as a receptacle for the floating seal assembly.

The method includes providing a first tubular having a box end. The box end includes a first shoulder, a sealing surface adjacent to the first shoulder, a first distal portion, and first threads disposed between the sealing surface and the first distal portion. The method further includes providing a second tubular having a pin end. The pin end includes a second shoulder, a second distal portion comprising an extended lip, and second threads disposed between the second shoulder and the extended lip. A first swellable element is disposed around an outer circumference of the extended lip. The method also includes forming the expandable connection by engaging the box end and the pin end, expanding the expandable connection, and sealing the expandable connection using the extended lip and the first swellable element.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an exemplary expandable tubular system in accordance with one or more embodiments.

FIG. 2 shows an expandable connection system in accordance with one or more embodiments.

FIGS. 3A-3B show the expandable connection system at different points during expansion in accordance with one or more embodiments.

FIG. 4 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments disclosed herein are directed to systems and methods for sealing and repairing leaks within expandable tubulars' expandable connections while the expandable tubulars are downhole. The system in place includes primary and secondary sealing elements that are installed within an expandable connection between two expandable tubulars. The sealing elements include an extended lip and swellable element(s). The extended lip acts to seal/repair the expandable connection during the process of expansion, and the swellable element(s) act to seal/repair the expandable connection immediately after expansion and/or during the production life of a well. The seals or swellable elements disclosed herein do not sacrifice outer diameter of the expandable tubular, which is critical for minimizing total outer diameter for expandable tubular equipment. In particular, embodiments disclosed herein are for use of a seal or swellable element in the expandable connection of an expandable tubular, to support leakage at the thread, intended to seal against leakage from inside the expandable tubular to the annulus.

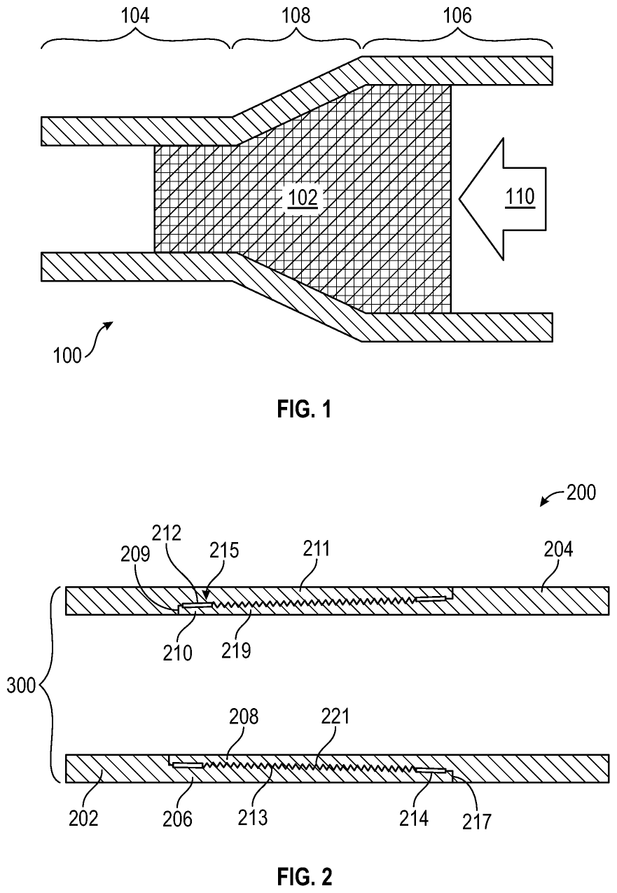

FIG. 1 depicts an exemplary expandable tubular (100) system in accordance with one or more embodiments. The primary components of the expandable tubular (100) system include the expandable tubular (100) (i.e., the tubular that is to be expanded) and an expansion element (102). The expansion element (102) may be any expansion element (102) known in the art such as an expansion cone. The expandable tubular (100) is a cylindrical pipe made of a material that is designed to plastically deform, such as a high strength sheet metal like steel. During an expansion process, the outer diameter of the expansion element (102) exerts a force on the internal diameter of the expandable tubular (100). The expandable tubular (100) is expanded outward with a permanent plastic deformation in a range determined by the geometries and the material properties of the expandable tubular (100) and the expansion element (102).

As the expansion element (102) passes through the inside of the expandable tubular (100), the unexpanded section (104) is worked upon by the expansion element (102) to expand the expandable tubular (100) (i.e., increase the inner diameter and the outer diameter). The section of the expandable tubular (100) that has been expanded may be called the expanded section (106), the section of the expandable tubular (100) that is being worked by the expansion element (102) may be called the transition section (108), and the section of the expandable tubular (100) that has not been expanded may be called the unexpanded section (104).

Pressure (110) is applied to the expansion element (102) to push the expansion element (102) through the expandable tubular (100) in order to work upon, or plastically deform, the expandable tubular (100). The pressure (110) may be applied by pumping on the expansion element (102) using a fluid such as completions fluid. The expansion element (102) may be pumped to the bottom of the well to expand the entirety of an expandable tubular string.

FIG. 2 depicts a system for sealing and repairing an expandable connection (200) between two tubulars including a first tubular (202) and a second tubular (204). The first tubular (202) and the second tubular (204) may be conventional tubulars that are not designed to plastically deform and expand. In other embodiments, the first tubular (202) and the second tubular (204) may be expandable tubulars (100) as described in FIG. 1. Components of FIG. 2 that are similar to components described in FIG. 1 have not been redescribed for purposes of readability and have the same functionalities as previously described. The first tubular (202) and the second tubular (204) may be made of any material that is required for the operation of the tubular, such as steel. The first tubular (202) and the second tubular (204) are formed in a cylindrical shape having an inner diameter and an outer diameter.

In one or more embodiments, the system depicted in FIG. 2 shows the first tubular (202) and the second tubular (204) pre-expansion (i.e., the unexpanded section (104) depicted in FIG. 1). A box end (206) is disposed at a first end of the first tubular (202) and a pin end (208) is disposed at a second end of the second tubular (204). The box end (206) has a first shoulder (209) that tapers off the box end (206) and creates a first distal portion (211). The first distal portion (211) has an inner circumferential surface having a plurality of first threads (213). The first threads (213) are disposed between a sealing surface (215), located adjacent to the first shoulder (209), and the end of the first distal portion (211). The first threads (213) correspond to a plurality of second threads (221) disposed around an outer circumferential surface of the pin end (208).

Specifically, the pin end (208) has a second shoulder (217) that tapers off the pin end (208) and creates a second distal portion (219). The second distal portion (219) has the outer circumferential surface where the second threads (221) are disposed around. The second threads (221) are disposed between the second shoulder (217) and an extended lip (210). The expandable connection (200) is formed when the pin end (208) is inserted and screwed into the box end (206) using the first threads (213) and second threads (221). The first threads (213) and the second threads (221) may be any type of threads known in the art such as standard, square, ACME, or buttress threads.

The second distal portion (219) of the pin end (208) may have the extended lip (210). The extended lip (210) may be machined as a permanent component of the second distal portion (219) of the pin end (208). The extended lip (210) may be made of the same material as the first tubular (202) and the second tubular (204) or be made of a different material that may achieve plastic deformation under different loads than the loads exerted upon the first tubular (202) and the second tubular (204). The extended lip (210) is an extension of the second distal portion (219) of the pin end (208) and is designed to plastically deform when the expansion element (102) passes through the extended lip (210). The extended lip (210) may be plastically deformed in an outwardly radial direction to form an inner seal preventing fluid from leaking from the inside of the expandable connection (200) to the outside of the expandable connection (200).

A first swellable element (212) may be disposed around an outer circumference of the extended lip (210). The first swellable element (212) is designed to create a seal within the expandable connection (200). Specifically, the first swellable element (212) seals against the sealing surface (215) located adjacent to the first shoulder (209) of the box end (206). The first swellable element (212) may seal the space between the threads of the pin end (208) and the threads of the box end (206). The first swellable element (212) may be fixed to the outer circumference of the extended lip (210) by being bonded or being mechanically fixed in position in a groove, for example if the swellable element is an O-ring. The first swellable element (212) may be mechanically fixed to the extended lip (210) by using internal forces of the material, slightly stretched around the pin end (208), to hold the first swellable element (212) in place.

A second swellable element (214) may be disposed around an inner circumference of the box end (206). The second swellable element (214) may be fixed to the box end (206) by being bonded. The first swellable element (212) and the second swellable element (214) may be made of an elastomer-type material that is designed to swell in size. The first swellable element (212) and the second swellable element (214) may be designed to swell in size after contact with an activation fluid or after a set amount of time.

The first swellable element (212) and the second swellable element (214) may come into contact with the activation fluid initially as the expansion process of the first tubular (202) and the second tubular (204) occurs. Alternatively, the first swellable element (212) and the second swellable element (214) may come into contact with the activation fluid after a leak occurs within the expandable connection (200). The activation fluid may be any fluid, such as water or production fluids. The swelling action of the first swellable element (212) and the second swellable element (214) reinforces the seal within the expandable connection (200) and may act as a backup in a scenario where the extended lip (210) fails to properly seal the expandable connection (200).

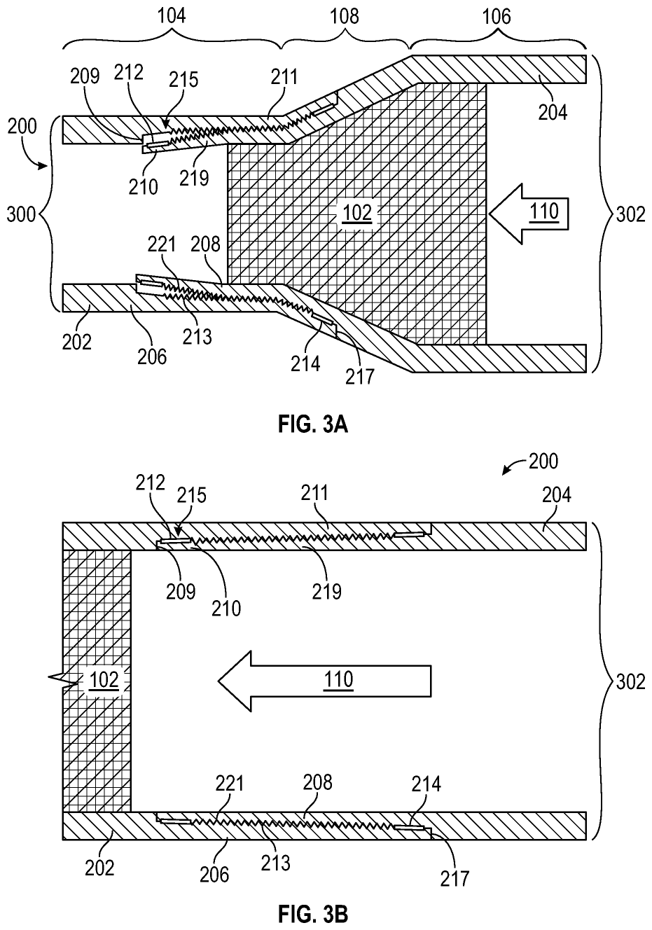

FIGS. 3a and 3b depict expandable connection (200) system described above in one or more embodiments. Specifically, FIG. 3a shows the system of FIG. 2 in the process of expansion, and FIG. 3b shows the system of FIG. 2 post expansion. Components shown in FIGS. 3a and 3b that are identical or similar to the components described in FIGS. 1 and 2 have not been redescribed for purposes of readability and have the same description and function as previously disclosed.

FIG. 3a shows the expandable connection (200) between the first tubular (202) and the second tubular (204) in the process of expansion. The embodiment depicted shows the expandable connection (200) having an unexpanded section (104), a transition section (108), and an expanded section (106). An expansion element (102) is present and is exerting force on the inner diameter of the second tubular (204). This force may be a conical force from the cone-shape of the expansion element (102). The expansion element (102) may have a pressure (110) applied to push the expansion element (102) through the expandable connection (200). As the expandable connection (200) is being worked upon by the expansion element (102), the pin end (208) and the extended lip (210) of the second tubular (204) may deform inwards, as shown in FIG. 3a.

Moving to FIG. 3b, the expandable connection (200) is shown as fully expanded (i.e., the expansion element (102) has pushed all the way through the expandable connection (200) and the expandable connection (200) has been plastically deformed from a first outer diameter (300) to a second outer diameter (302)). As the expansion element (102) passes through the expandable connection (200), the extended lip (210) may be plastically deformed to press against the first tubular (202) creating the inner seal within the expandable connection (200).

The first swellable element (212) and the second swellable element (214) are shown within the expandable connection (200). If the expandable connection (200) begins to leak after the expansion process, the first swellable element (212) and the second swellable element (214) may be activated by fluids that are in the tubing at the time. Alternatively, activation of the swellable elements may be time-based. Thus, after activation, the first swellable element (212) and the second swellable element (214) may swell and seal/repair the expandable connection (200).

In other embodiments, as the expansion element (102) passes through the expandable connection (200), the expandable connection (200) may completely separate in an axial direction due to a connection failure. Upon separation, the extended lip (210) of the pin end (208) acts as a floating seal assembly and the box end (206) may act as a receptacle. This means that the second tubular (204), may be picked up and inserted into the first tubular (202) downhole allowing the pin end (208) to enter the box end (206). In this scenario, the first threads (213) and the second threads (221) may not re-engage, and the extended lip (210) will act as the primary seal within the expandable connection (200).

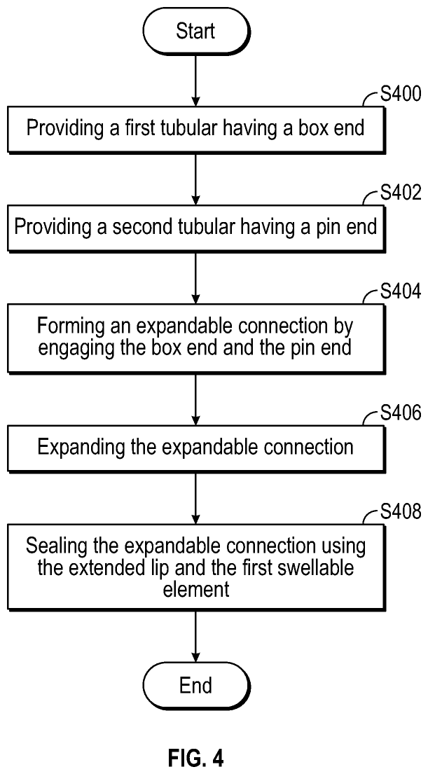

FIG. 4 depicts a flowchart in accordance with one or more embodiments. More specifically, FIG. 4 illustrates a method for sealing and repairing an expandable connection (200) between a first tubular (202) and a second tubular (204) downhole. Further, one or more blocks in FIG. 4 may be performed by one or more components as described in FIGS. 1-3b. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially, a first tubular (202) having a box end (206) and a second tubular (204) having a pin end (208) are provided (S400 and S402). The box end (206) has a first shoulder (209) that tapers off the box end (206) and creates a first distal portion (211). The first distal portion (211) has an inner circumferential surface having a plurality of first threads (213). The first threads (213) are disposed between a sealing surface (215), located adjacent to the first shoulder (209), and the end of the first distal portion (211). The first threads (213) correspond to a plurality of second threads (221) disposed around an outer circumferential surface of the pin end (208).

Specifically, the pin end (208) has a second shoulder (217) that tapers off the pin end (208) and creates a second distal portion (219). The second distal portion (219) has the outer circumferential surface where the second threads (221) are disposed around. The second threads (221) are disposed between the second shoulder (217) and an extended lip (210). The first tubular (202) and the second tubular (204) may be expandable tubulars (100). An expandable connection (200) is formed by engaging the box end (206) and the pin end (208) (S404). The pin end (208) and the box end (206) are engaged when the pin end (208) is screwed into the box end (206) using the first threads (213) and the second threads (221).

The second distal portion (219) of the pin end (208) may have the extended lip (210). A first swellable element (212) may be disposed around an outer circumference of the extended lip (210). The first swellable element (212) may be mechanically fixed to the extended lip (210), or the first swellable element (212) may be bonded to the extended lip (210). A second swellable element (214) may be disposed around an inner circumference of the first distal portion (211) of the box end (206). The first swellable element (212) and the second swellable element (214) may be made of an elastomer that is designed to swell in size. The first swellable element (212) and the second swellable element (214) may swell when they encounter an activation fluid, such as water or production fluids.

The expandable connection (200) is expanded (S406) when an expansion element (102) is pushed through the expandable connection (200) by a pressure (110) applied by a fluid. As the expandable connection (200) between the first tubular (202) and the second tubular (204) is expanded from a first outer diameter (300) to a second outer diameter (302), the expandable connection (200) may deform and develop a leak. The expandable connection (200) is sealed using the extended lip (210) and the first swellable element (212) (S408). As the expansion element (102) passes through the expandable connection (200), the extended lip (210) may be plastically deformed radially outwards (i.e., expanded) to be pressed against the box end (206), sealing any leaks caused by a deformation in the expansion process. Further, the first swellable element (212) and the second swellable element (214) may come in contact with the activation fluid prior to, during, or after the expansion process causing the first swellable element (212) and the second swellable element (214) to swell and seal any leaks that may not have been sealed by the extended lip (210).

Embodiments described above discuss a sealing system with sealing factors including an extended lip (210), a first swellable element (212), and a second swellable element (214); however, those of ordinary skill in the art will appreciate that a sealing system comprising one or more of the sealing factors may be used without departing from the scope of the disclosure herein. Further, more than two swellable elements may be used within a singular expandable connection without departing from the scope of this disclosure. Those skilled in the art with also appreciate that a singular tubular, such as the first tubular (202), may have both a box end (206) and pin end (208) (disposed on opposite sides of the tubular), and the sealing system may occur at both ends of the tubular where an expandable connection (200) exists.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112f for any limitations of any of the claims herein, except for those in which the claim expressly uses the words ‘means for’ together with an associated function.

What is claimed:

1. A system for sealing an expandable connection between a first tubular and a second tubular, the system comprising:
a box end disposed at a first end of the first tubular, the box end comprising:
a first shoulder;
a sealing surface adjacent to the first shoulder;
a first distal portion; and
first threads disposed between the sealing surface and the first distal portion;
a pin end disposed at a second end of the second tubular, the pin end comprising:
a second shoulder;
a second distal portion comprising an extended lip; and
second threads disposed between the second shoulder and the extended lip; and
a first swellable element disposed around an outer circumference of the extended lip,
wherein the pin end is inserted into the box end to form the expandable connection, and
wherein upon expansion of the expandable connection the first swellable element seals against the sealing surface.

2. The system of claim 1,
wherein, upon separation of the expandable connection, the extended lip of the pin end acts as a floating seal assembly with the box end acting as a receptacle for the floating seal assembly.

3. The system of claim 1,
wherein the first swellable element is bonded to the outer circumference of the extended lip.

4. The system of claim 1,
wherein the first swellable element is configured to swell when placed in contact with an activation fluid.

5. The system of claim 1, further comprising:
an expansion element configured to expand the expandable connection from a first outer diameter to a second outer diameter.

6. The system of claim 5,
wherein the expansion element expands the extended lip against the sealing surface to seal the expandable connection.

7. The system of claim 1, further comprising:
a second swellable element disposed around an inner circumference of the first distal portion of the box end.

8. The system of claim 7,
wherein the second swellable element is configured to swell when placed in contact with an activation fluid.

9. The system of claim 8,
wherein the first swellable element and the second swellable element are placed into contact with the activation fluid when a leak occurs in the expandable connection.

10. The system of claim 7,
wherein the first swellable element and the second swellable element are configured to swell and seal the expandable connection after a set amount of time.

11. A method for sealing an expandable connection:
providing a first tubular having a box end, the box end comprising:
a first shoulder;
a sealing surface adjacent to the first shoulder;
a first distal portion; and
first threads disposed between the sealing surface and the first distal portion;
providing a second tubular having a pin end, the pin end comprising:
a second shoulder;
a second distal portion comprising an extended lip; and
second threads disposed between the second shoulder and the extended lip,
wherein a first swellable element is disposed around an outer circumference of the extended lip;
forming the expandable connection by engaging the box end and the pin end;
expanding the expandable connection; and
sealing the expandable connection using the extended lip and the first swellable element.

12. The method of claim 11, further comprising:
mechanically fixing the first swellable element to the outer circumference of the extended lip.

13. The method of claim 11, further comprising:
bonding the first swellable element to the outer circumference of the extended lip.

14. The method of claim 11,
wherein sealing the expandable connection further comprises placing the first swellable element in contact with an activation fluid.

15. The method of claim 11,
wherein expanding the expandable connection further comprises using an expansion element and a pressure.

16. The method of claim 15,
wherein sealing the expandable connection further comprises expanding the extended lip, using the expansion element.

17. The method of claim 11,
wherein the box end further comprises a second swellable element disposed around an inner circumference of the box end.

18. The method of claim 17,
wherein sealing the expandable connection further comprises placing the second swellable element in contact with an activation fluid.

19. The method of claim 18,
wherein sealing the expandable connection further comprises, upon development of a leak within the expandable connection, placing the first swellable element and the second swellable element into contact with the activation fluid.

20. The method of claim 17,
wherein sealing the expandable connection further comprises swelling the first swellable element and the second swellable element after a set amount of time.
